(19) United States
(12) Patent Application Publication
(10) Pub. No.: US 2021/0221252 A1
(43) Pub. Date: Jul. 22, 2021

(54) VEHICLE

(71) Applicant: TOYOTA JIDOSHA KABUSHIKI KAISHA, Aichi-ken (JP)

(72) Inventors: Toshio WATANABE, Toyota-shi (JP); Keisuke SHIBATA, Miyoshi-shi, Aichi-ken (JP); Kenta MIYAHARA, Toyota-shi, Aichi-ken (JP)

(21) Appl. No.: 17/060,084

(22) Filed: Oct. 1, 2020

(30) Foreign Application Priority Data
Jan. 22, 2020 (JP) 2020-008762

(51) Int. Cl. B60L 58/24; B60K 1/04; B60K 11/04

(52) U.S. Cl. CPC B60L 58/24; B60K 1/04; B60K 11/04; B60K 2001/0438; B60L 2240/545; B60L 2240/665; B60L 2240/34

(57) ABSTRACT

A vehicle includes a battery pack as a temperature control target that needs to be subjected to temperature control, a radiator which is a heat exchanger configured such that a heating medium circulates between the battery pack and the heat exchanger, a cover member that covers the radiator and forms an upper surface of a vehicle body and of which the transparency is changeable, a solar radiation detection unit configured to detect solar radiation, and a controller that is able to change the transparency of the cover member based on the result of detection performed by the solar radiation detection unit.

### CROSS-REFERENCE TO RELATED APPLICATION

This application claims priority to Japanese Patent Application No. 2020-008762 filed on Jan. 22, 2020, incorporated herein by reference in its entirety.

### BACKGROUND

### 1. Technical Field

The present disclosure relates to a vehicle.

### 2. Description of Related Art

A vehicle described in Japanese Unexamined Patent Application Publication No. 2006-188167 (JP 2006-188167 A) includes a gas fuel tank that is disposed at a roof portion, a radiator that is disposed at the roof portion while being disposed rearward of the gas fuel tank in a vehicle front-rear direction, and a cover member that covers the roof portion. The cover member is provided with an upper outside air introduction port for introduction into the radiator of outside air that passes through a space above the roof portion as the vehicle travels. Accordingly, a space in which the gas fuel tank is disposed is ensured with radiator cooling efficiency made favorable.

### SUMMARY

Meanwhile, for example, in a case where a radiator is for water cooling of a battery pack of an electric vehicle or the like, warming a coolant by heating the radiator at the time of activation of the battery pack results in an improvement in performance of the battery pack. Particularly, in a cold region, the performance of the battery pack at the time of activation is significantly lowered and thus it is preferable to warm the battery pack by warming the coolant. The energy of sunlight can be used for the warming of the battery pack, for example. However, the above-described related art has not been made in consideration of such a point.

The disclosure provides a vehicle in which a heat exchanger such as a radiator can be irradiated with sunlight as needed.

A first aspect of the disclosure relates to a vehicle including a temperature control target, a heat exchanger, a cover member, a solar radiation detection unit, and a controller. The temperature control target needs to be subjected to temperature control. The heat exchanger is configured such that a heating medium circulates between the temperature control target and the heat exchanger. The cover member covers the heat exchanger and forms an upper surface of a vehicle body and the transparency of the cover member is changeable. The solar radiation detection unit is configured to detect solar radiation. The controller is able to change the transparency based on the result of detection performed by the solar radiation detection unit.

Note that, “solar radiation” described in the first aspect means “an event that the sun shines”.

In the first aspect, the heating medium circulates between the temperature control target that needs to be subjected to temperature control and the heat exchanger (for example, radiator). The heat exchanger forms the upper surface of the vehicle body and is covered by the cover member of which the transparency is changeable. In addition, the controller is able to change the transparency of the cover member based on the result of detection performed by the solar radiation detection unit that detects solar radiation. Accordingly, the heat exchanger such as a radiator can be irradiated with sunlight as needed.

According to a second aspect of the disclosure, the vehicle related to the first aspect may further include a state detection unit configured to detect the state of the temperature control target and the controller may be able to change the transparency based on the result of detection performed by the state detection unit.

In the second aspect, the controller is able to change the transparency of the cover member based on the result of detection performed by the state detection unit that detects the state of the temperature control target (for example, whether or not cooling or heating needs to be performed). Accordingly, the amount of sunlight with which the heat exchanger is irradiated can be changed in accordance with the state of the temperature control target.

According to a third aspect of the disclosure, in the vehicle related to the second aspect, the temperature control target may be a battery pack and the state detection unit may be able to detect the temperature of the battery pack.

In the third embodiment, the amount of sunlight with which the heat exchanger is irradiated can be changed in accordance with the temperature of the battery pack.

According to a fourth aspect of the disclosure, in the vehicle related to the second or third aspect, the temperature control target may be a battery pack and the state detection unit may be able to detect the state of use of the battery pack.

In the fourth embodiment, the amount of sunlight with which the heat exchanger is irradiated can be changed in accordance with the state of use (for example, voltage, electric current, continuous use time, amount of remaining electric power) of the battery pack.

According to a fifth aspect of the disclosure, in the vehicle related to any one of the second to fourth aspects, the temperature control target may be a battery pack installed below a floor of a vehicle cabin and the state detection unit may be able to detect the temperature of the vehicle cabin.

In the fifth aspect, the amount of the sunlight with which the heat exchanger is irradiated can be changed in accordance with the temperature of the vehicle cabin correlated with the temperature of the battery pack installed below the floor of the vehicle cabin.

According to a sixth aspect of the disclosure, in the vehicle related to any one of the first to fifth aspects, the solar radiation detection unit is able to detect the amount of solar radiation.

Note that, “the amount of solar radiation” described in the sixth aspect means “the amount of energy radiated from the sun”.

In the sixth aspect, the amount of sunlight with which the heat exchanger is irradiated can be changed in accordance with the amount of solar radiation.

According to a seventh aspect of the disclosure, the vehicle related to any one of the first to sixth aspects may further include an outside temperature detection unit configured to detect the temperature of the outside of the vehicle. The controller may be able to change the transparency based on the result of detection performed by the outside temperature detection unit.

In the seventh aspect, the controller is able to change the transparency of the cover member based on the result of detection performed by the outside temperature detection unit that detects the outside temperature. Accordingly, the amount of sunlight with which the heat exchanger is irradiated can be changed in accordance with the outside temperature.

According to an eighth aspect of the disclosure, in the vehicle related to any one of the first to seventh aspects, the heat exchanger may be installed in a roof portion of the vehicle body and the cover member may form an upper surface of the roof portion.

In the eighth aspect, the heat exchanger installed in the roof portion of the vehicle body is covered by the cover member that forms the upper surface of the roof portion and the transparency of the cover member is changed by the controller. Accordingly, the heat exchanger installed in the roof portion can be irradiated with sunlight as needed.

According to a ninth aspect of the disclosure, in the vehicle related to the eighth aspect, the heat exchanger may be a radiator and an introduction hole for introduction of traveling wind into the roof portion may be formed in the roof portion or a pillar of the vehicle body.

In the ninth aspect, traveling wind can be introduced into the roof portion through the introduction hole formed in the roof portion or the pillar of the vehicle body such that the traveling wind hits the radiator installed in the roof portion.

According to a tenth aspect of the disclosure, the vehicle related to the ninth aspect citing the eighth aspect citing the second aspect may further include an opening and closing mechanism configured to open and close the introduction hole. The controller may control the opening and closing mechanism based on the result of detection performed by the solar radiation detection unit and the state detection unit.

In the tenth aspect, the controller controls the opening and closing mechanism based on the result of detection performed by the solar radiation detection unit that detects solar radiation and the result of detection performed by the state detection unit that detects the state of the temperature control target. Accordingly, the introduction hole formed in the roof portion or the pillar of the vehicle body can be opened and closed and whether or not traveling wind is introduced into the roof portion in which the radiator is installed can be changed based on the result of the detection.

As described above, in the vehicle according to the aspects of the disclosure, the heat exchanger such as the radiator can be irradiated with sunlight as needed.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a sectional view of a portion of a vehicle according to a first embodiment as seen from the left side thereof;

FIG. 2 is a block diagram showing the configuration of a vehicle temperature control system installed in the vehicle according to the first embodiment;

FIG. 3 is a flowchart showing an example of a control procedure for a light control film in the vehicle temperature control system according to the first embodiment;

FIG. 4 is a block diagram showing the configuration of a vehicle temperature control system installed in a vehicle according to a second embodiment;

FIG. 5 is a flowchart showing an example of a control procedure for a light control film in the vehicle temperature control system according to the second embodiment;

FIG. 6 is a sectional view of a portion of a vehicle according to a third embodiment as seen from the left side thereof;

FIG. 7 is a block diagram showing the configuration of a vehicle temperature control system installed in the vehicle according to the third embodiment;

FIG. 8 is a flowchart showing an example of a control procedure for an opening and closing mechanism in the vehicle temperature control system according to the third embodiment;

FIG. 9 is a block diagram showing the configuration of a vehicle temperature control system installed in a vehicle according to a fourth embodiment;

FIG. 10 is a flowchart showing an example of a control procedure for a light control film in the vehicle temperature control system according to the fourth embodiment; and

FIG. 11 is a flowchart showing an example of a control procedure for an opening and closing mechanism in the vehicle temperature control system according to the fourth embodiment.

### DETAILED DESCRIPTION OF EMBODIMENTS

### First Embodiment

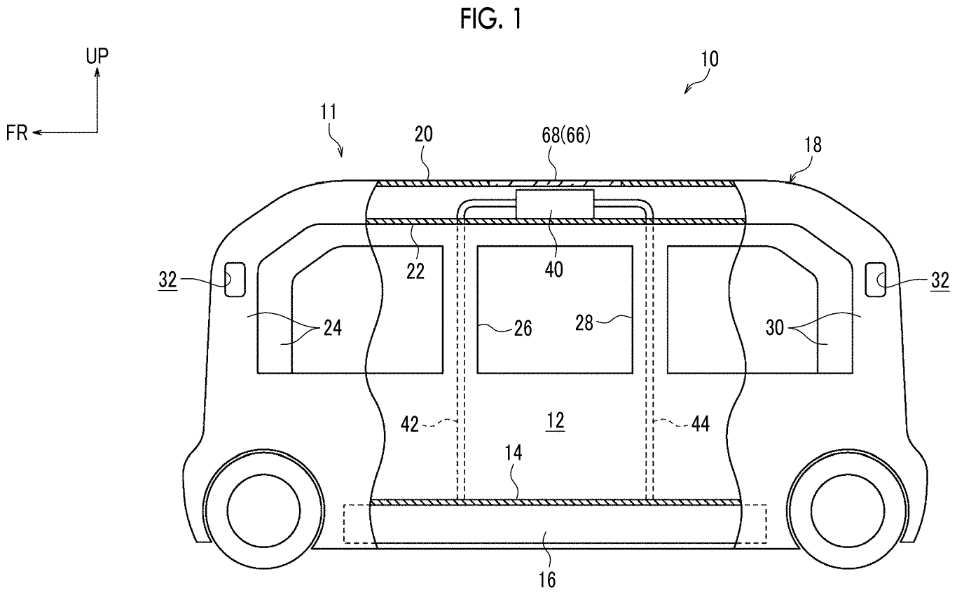

Hereinafter, a vehicle 10 according to a first embodiment of the disclosure will be described with reference to FIGS. 1 to 3. Note that, an arrow FR and an arrow UP in FIG. 1 denote a direction toward a vehicle front side and a direction toward a vehicle upper side, respectively. Hereinafter, in a case where the description is made while using frontward and rearward directions and upward and downward directions simply, the frontward and rearward directions and the upward and downward directions mean frontward and rearward directions in a vehicle front-rear direction and upward and downward directions in a vehicle height direction unless otherwise noted.

Configuration

As shown in FIG. 1, the vehicle 10 according to the present embodiment is, for example, a small occupant transportation bus and is an electric vehicle that can be autonomously driven. A battery pack 16 is installed below a floor of a vehicle cabin 12 of the vehicle 10, that is, at a lower surface side of a floor panel 14. The battery pack 16 is configured to include a plurality of battery modules (not shown), each of which is composed of a plurality of battery cells connected to each other, and a battery pack ECU 17, which will be described, and the battery pack 16 is a temperature control target that needs to be subjected to temperature control (temperature management). The vehicle 10 is configured to travel by using electric power of the battery pack 16. The vehicle 10 is configured to be symmetrical in a front-rear direction and can travel in the same manner for any of a frontward direction and a rearward direction.

In addition, a radiator 40, which is a heat exchanger, is installed in a roof portion 18 of the vehicle 10. Specifically, the roof portion 18 includes an outer panel 20 that forms an upper surface (design surface) of a vehicle body 11 and an inner panel 22 that is disposed to be separated from the outer panel 20 while being positioned below the outer panel 20. The radiator 40 is disposed between the outer panel 20 and the inner panel 22. The radiator 40 is positioned at, for example, a center portion of the vehicle 10 in the front-rear direction.

An introduction hole 32 is formed in each of A-pillars 24 and D-pillars 30 of the vehicle 10. While the vehicle 10 is traveling forward, traveling wind is introduced into the roof portion 18 through the introduction holes 32 formed in the A-pillars 24 and is discharged through the introduction holes 32 formed in the D-pillars 30. Meanwhile, while the vehicle 10 is traveling rearward, traveling wind is introduced into the roof portion 18 through the introduction holes 32 formed in the D-pillars 30 and is discharged through the introduction holes 32 formed in the A-pillars 24. In addition, when traveling wind is introduced into the roof portion 18 as described above, the traveling wind hits the radiator 40.

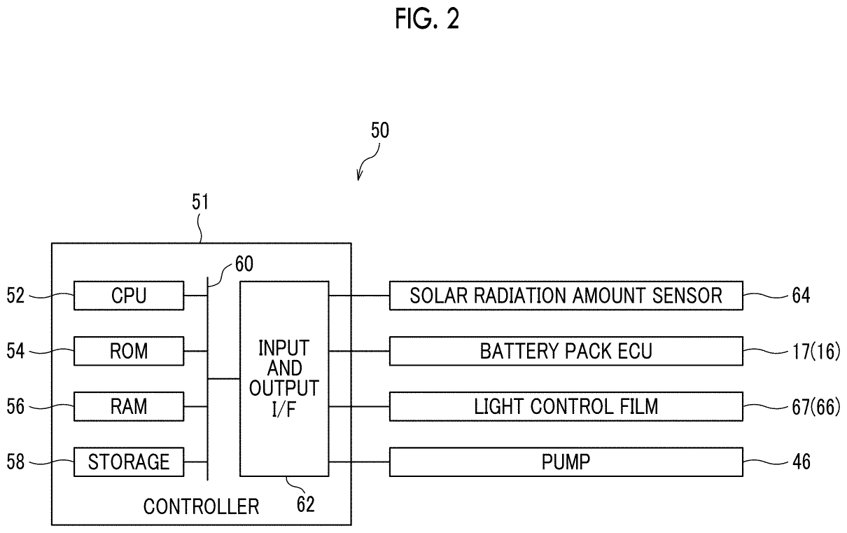

The radiator 40 and the battery pack 16 are connected to each other via a pair of pipes 42, 44. The pipes 42, 44 are routed in B-pillars 26 and C-pillars 28 of the vehicle 10, for example. In the battery pack 16, a pump 46 (refer to FIG. 2; omitted in FIG. 1), which is a liquid pump, is provided. When the pump 46 is operated, a heating medium (for example, water) circulates between the battery pack 16 and the radiator 40 through the pipes 42, 44. In the battery pack 16, a water jacket (not shown) through which the heating medium flows is provided and the temperature of the battery pack 16 is controlled through circulation of the heating medium, for example.

The pump 46 is electrically connected to a controller 51 (refer to FIG. 2; not shown in FIG. 1) installed in the vehicle 10. The controller 51 includes a central processing unit (CPU) 52, a random access memory (RAM) 54, a read-only memory (ROM) 56, a storage 58, and an input and output interface (I/F) 62. The CPU 52, the RAM 54, the ROM 56, the storage 58, and the input and output I/F 62 are connected to each other via the bus 60 such that the CPU 52, the RAM 54, the ROM 56, the storage 58, and the input and output I/F 62 can communicate with each other.

The CPU 52 is a central processing unit, executes various programs, and controls each unit. That is, the CPU 52 reads a program from the ROM 56 and executes the program while using the RAM 54 as a work area. In the present embodiment, a control program is stored in the ROM 56.

The ROM 56 stores various programs and various data. The RAM 54 temporarily stores a program or data, as a work area. The storage 58 is composed of a hard disk drive (HDD) or a solid-state drive (SSD) and stores various programs including an operating system and various data.

In addition to the pump 46, a solar radiation amount sensor 64 which is a solar radiation detection unit, the battery pack electronic control unit (ECU) 17 which is a state detection unit, and a light control film 67 are electrically connected to the input and output I/F 62. The controller 51, the solar radiation amount sensor 64, the battery pack ECU 17, the light control film 67, and the pump 46 constitute a vehicle temperature control system 50.

The solar radiation amount sensor 64 is provided at an installment panel portion (not shown) of the vehicle 10 and detects the amount of solar radiation. The solar radiation amount sensor 64 is configured to detect a change of an electric current flowing through a photodiode built thereinto as the intensity of sunlight. The battery pack ECU 17 is provided in the battery pack 16 and is able to detect the temperature and the state of use of the battery pack 16. The state of use includes, for example, the voltage, the electric current, the continuous use time, and the amount of remaining electric power of the battery pack 16. The battery pack ECU 17 grasps the temperature or the state of use of the battery pack 16 and monitors input and output to the battery pack 16.

The light control film 67 is provided on a cover member 66 provided on the roof portion 18. The cover member 66 is composed of, for example, a transparent plate 68 formed of a transparent glass plate or a resin plate and the light control film 67 (see FIG. 2; omitted in FIG. 1) pasted to the transparent plate 68 and is disposed such that a plate thickness direction thereof becomes parallel to the vehicle height direction. The cover member 66 is disposed above the radiator 40 and covers the radiator 40 from above. The cover member 66 forms an upper surface of the vehicle body 11 together with the outer panel 20.

The light control film 67 included in the cover member 66 is, for example, a liquid crystal light control film and the transparency of which is changeable. Specifically, the light control film 67 is in a so-called normal-mode film which becomes transparent when the film is energized and becomes opaque when the film is not energized. Note that, the light control film 67 may be a so-called reverse-mode film which becomes opaque when the film is energized and becomes transparent when the film is not energized.

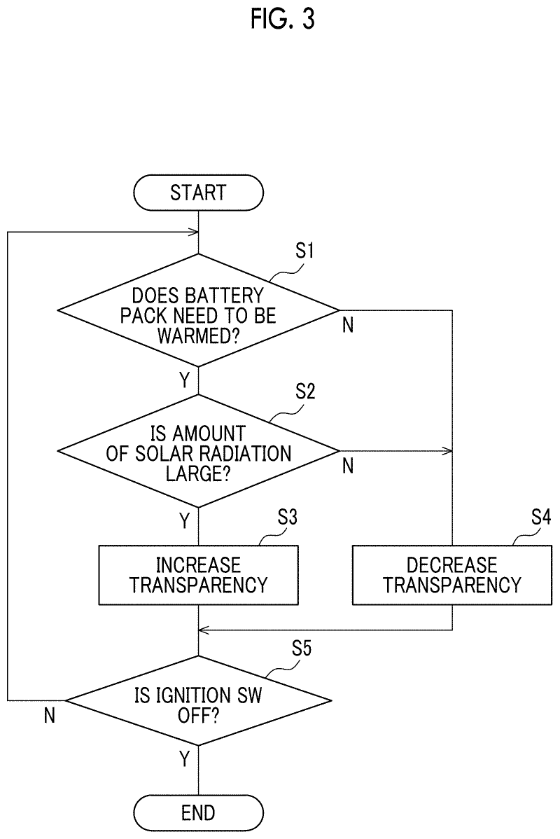

Next, an example of a control procedure for the light control film 67 (cover member 66) in the vehicle temperature control system 50 will be described using a flowchart shown in FIG. 3.

For example, when an ignition switch (not shown) of the vehicle 10 is turned on and the battery pack 16 is activated, the CPU 52 of the controller 51 starts to execute a control program for the light control film 67. In the control program, first, in step S1, the CPU 52 detects the temperature or the state of use of the battery pack 16 based on output from the battery pack ECU 17 and determines whether or not the battery pack 16 needs to be warmed. In a case where the result of the determination is negative, the processing proceeds to step S4 and in a case where the result of the determination is positive, the processing proceeds to step S2.

In a case where the processing proceeds to step S2, the CPU 52 determines whether or not the amount of solar radiation is equal to or greater than a pre-set threshold value (that is, whether or not amount of solar radiation is large) based on output from the solar radiation amount sensor 64. In a case where the result of the determination is negative, the processing proceeds to step S4 and in a case where the result of the determination is positive, the processing proceeds to step S3.

In a case where the processing proceeds to step S3, the CPU 52 starts energization of the light control film 67 such that the transparency of the light control film 67 is increased. As a result, the radiator 40 is irradiated with sunlight and the heating medium is heated by the heat of the sunlight. In addition, in step S3, the CPU 52 changes (adjusts) the transparency of the light control film 67 in accordance with the amount of solar radiation detected by the solar radiation amount sensor 64. Note that, although not shown in FIG. 3, the CPU 52 activates the pump 46 in step S3. When processing in step S3 is finished, the processing proceeds to step S5.

Meanwhile, in a case where the result of the determination in step S1 or step S2 is negative and the processing proceeds to step S4, the CPU 52 does not energize the light control film 67 such that the transparency of the light control film 67 is kept decreased. As a result, sunlight with which the radiator 40 is irradiated is blocked by the light control film 67. When processing in step S4 is finished, the processing proceeds to step S5.

In a case where the processing proceeds to step S5, the CPU 52 determines whether or not an ignition switch is off. In a case where the result of the determination is negative, the processing returns to step S1 such that the above-described processing is repeated and in a case where the result of the determination is positive, the control program for the light control film 67 is terminated.

Action and Effect

Next, the action and effect of the present embodiment will be described.

In the present embodiment, a heating medium circulates between the battery pack 16 that needs to be subjected to temperature control and the radiator 40. The radiator 40 forms an upper surface of the vehicle body 11 and is covered by the cover member 66 of which the transparency is changeable. In addition, the controller 51 is able to change the transparency of the cover member 66 based on the result of detection performed by the solar radiation amount sensor 64 that detects solar radiation. As a result, the radiator 40 can be irradiated with sunlight as needed and the battery pack 16 can be warmed.

In addition, in the present embodiment, the controller 51 is able to change the transparency of the cover member 66 based on the result of detection performed by the battery pack ECU 17 that detects the state of the battery pack 16 (for example, whether or not cooling or heating needs to be performed). Accordingly, the amount of sunlight with which the radiator 40 is irradiated can be changed in accordance with the state of the battery pack 16.

Specifically, since the battery pack ECU 17 is able to detect the temperature of the battery pack 16, the amount of sunlight with which the radiator 40 is irradiated can be changed in accordance with the temperature of the battery pack 16.

In addition, since the battery pack ECU 17 is able to detect the state of use (for example, voltage, electric current, continuous use time, amount of remaining electric power) of the battery pack 16, the amount of sunlight with which the radiator 40 is irradiated can be changed in accordance with the state of use.

Furthermore, in the present embodiment, the solar radiation amount sensor 64 is able to detect the presence or absence of solar radiation (that is, event that sun shines) and the amount of solar radiation (that is, amount of energy radiated from sun) and thus the amount of sunlight with which the radiator 40 is irradiated can be changed (finely adjusted) in accordance with the amount of solar radiation.

In addition, in the present embodiment, the radiator 40 installed in the roof portion 18 of the vehicle body 11 is covered by the cover member 66 that forms the upper surface of the roof portion 18 and the transparency of the cover member 66 is changed by the controller 51. Accordingly, the radiator 40 installed in the roof portion 18 can be irradiated with sunlight as needed.

In addition, in the present embodiment, traveling wind can be introduced into the roof portion 18 through the introduction holes 32 formed in the A-pillars 24 or the D-pillars 30 of the vehicle body 11 such that the traveling wind hits the radiator 40 installed in the roof portion 18.

Next, another embodiment of the disclosure will be described. Note that, regarding components and actions that are basically the same as those in the embodiment described already, the same reference numerals as those in the embodiment described already are given and description thereof will be omitted.

### Second Embodiment

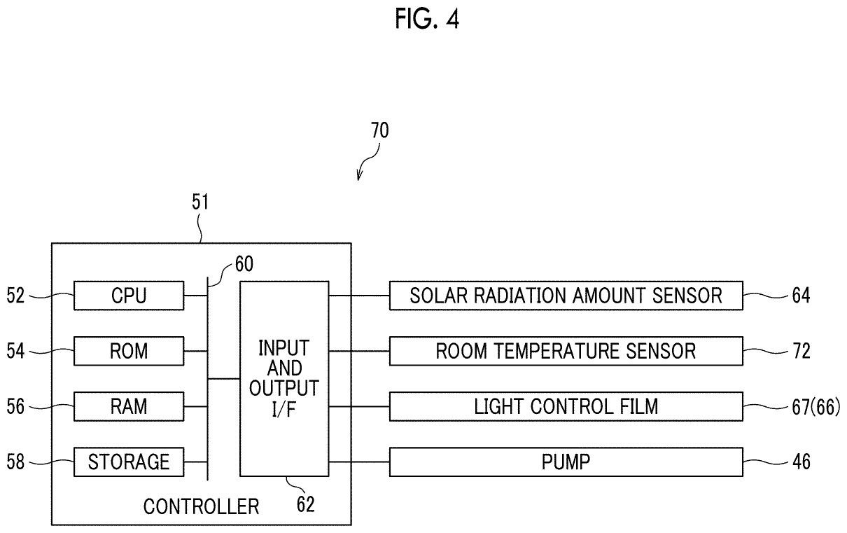

FIG. 4 is a block diagram showing the configuration of a vehicle temperature control system 70 installed in a vehicle according to a second embodiment of the disclosure. In the vehicle temperature control system 70, instead of the battery pack ECU 17 described above, a room temperature sensor 72 is electrically connected to the input and output I/F 62 of the controller 51. The room temperature sensor 72 is provided in the vehicle cabin 12 and detects the room temperature of the vehicle cabin 12. The temperature of the vehicle cabin 12 changes in accordance with the temperature of the battery pack 16 installed below the floor of the vehicle cabin 12.

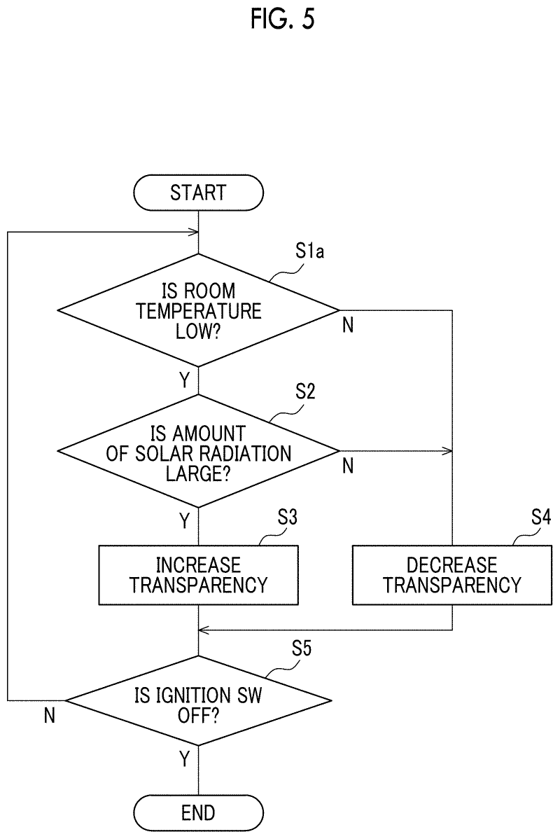

In the vehicle temperature control system 70, as with the first embodiment, when the ignition switch (not shown) of the vehicle 10 is turned on and the battery pack 16 is activated, the CPU 52 of the controller 51 starts to execute a control program for the light control film 67. In the control program, first, in step S1a, the CPU 52 determines whether or not the room temperature of the vehicle cabin 12 is low based on output from the room temperature sensor 72, as shown in FIG. 5. In other words, the CPU 52 indirectly detects the temperature of the battery pack 16 based on the temperature of the vehicle cabin 12 and determines whether or not the battery pack 16 needs to be warmed. In a case where the result of the determination is negative, the processing proceeds to step S4 and in a case where the result of the determination is positive, the processing proceeds to step S2.

In steps S2 to S5, the CPU 52 performs the same processing as in steps S2 to S5 in the first embodiment. In the present embodiment, configurations other than those described above are the same as the first embodiment.

In the present embodiment, whether or not the radiator 40 is irradiated with sunlight or the amount of the sunlight with which the radiator 40 is irradiated can be changed in accordance with the temperature of the vehicle cabin 12 correlated with the temperature of the battery pack 16 installed below the floor of the vehicle cabin 12.

### Third Embodiment

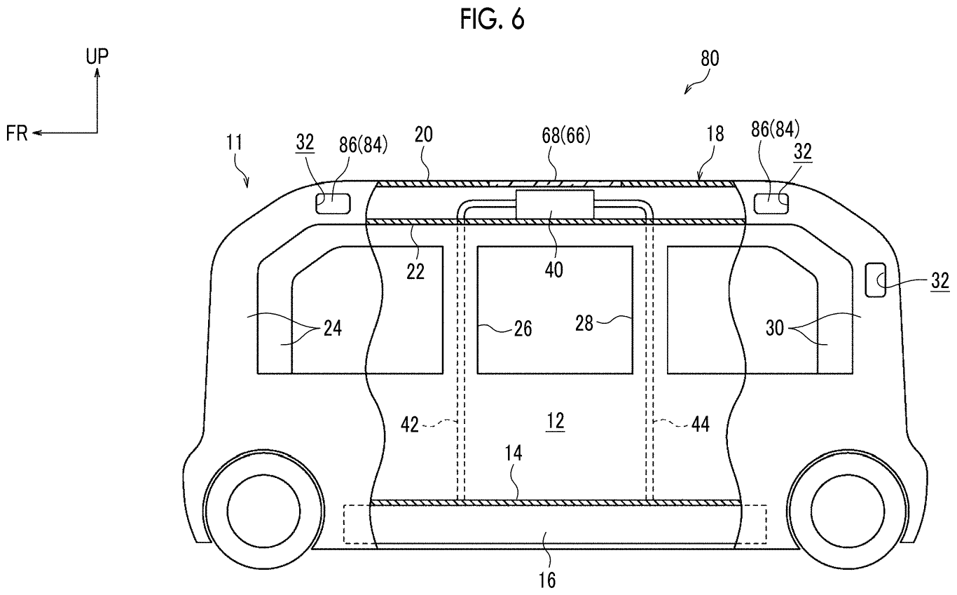

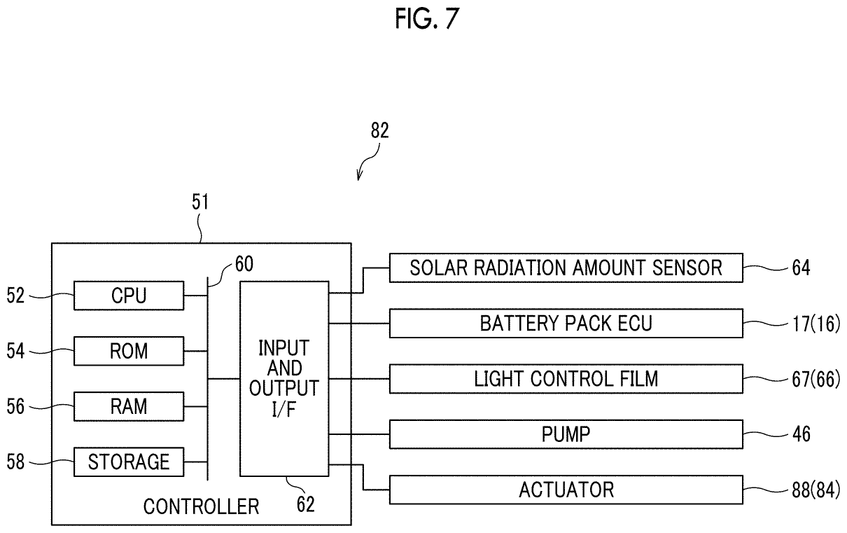

FIG. 6 is a sectional view of a portion of a vehicle 80 according to a third embodiment of the disclosure as seen from the left side thereof. In addition, FIG. 7 is a block diagram showing the configuration of a vehicle temperature control system 82 installed in the vehicle 80. As shown in FIG. 6, in the vehicle 80, the introduction holes 32 are formed in a front end portion and a rear end portion of the roof portion 18, respectively. Each introduction hole 32 is configured to be opened and closed by means of an opening and closing mechanism 84.

The opening and closing mechanism 84 includes a plurality of door portions 86 that is slidably attached to the roof portion 18 and opens and closes the introduction holes 32 and a plurality of actuators 88 (refer to FIG. 7; omitted in FIG. 6) that causes the door portions 86 to slide with respect to the roof portion 18. Note that, although an example in which the introduction holes 32 are formed in a side surface of the roof portion 18 is shown in FIG. 6, the introduction holes 32 may be formed in the upper surface of the roof portion 18. In addition, in FIG. 7, one actuator 88 is shown solely for the purpose of simplifying the description.

Each of the actuators 88 of the opening and closing mechanism 84 is electrically connected to the input and output I/F 62 of the controller 51. The actuators 88 constitute the vehicle temperature control system 82 together with the controller 51, the solar radiation amount sensor 64, the battery pack ECU 17, the light control film 67, and the pump 46.

The CPU 52 of the controller 51 is configured to control each actuator 88 of the opening and closing mechanism 84 based on the result of detection performed by the solar radiation amount sensor 64 and the battery pack ECU 17. Specifically, when an ignition switch (not shown) of the vehicle 80 is turned on and the battery pack 16 is activated, the CPU 52 of the controller 51 starts to execute a control program for the light control film 67 and to execute a control program for the opening and closing mechanism 84. The control program for the light control film 67 is the same as the control program in the first embodiment.

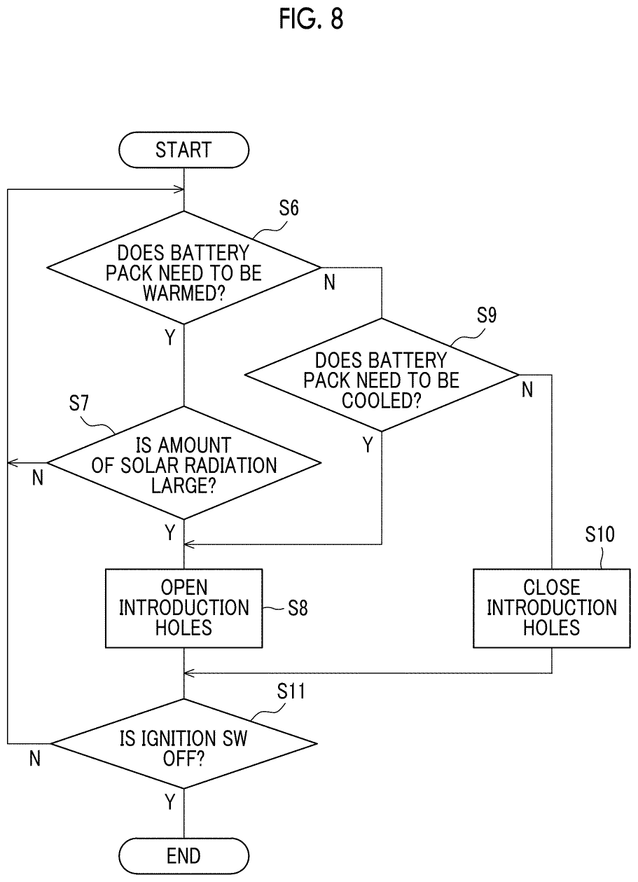

In the control program for the opening and closing mechanism 84, first, in step S6, the CPU 52 determines whether or not the battery pack 16 needs to be warmed based on output from the battery pack ECU 17, as shown in FIG. 8. In a case where the result of the determination is negative, the processing proceeds to step S9 and in a case where the result of the determination is positive, the processing proceeds to step S7.

In a case where the processing proceeds to step S7, the CPU 52 determines whether or not the amount of solar radiation is equal to or greater than a pre-set threshold value (that is, whether or not amount of solar radiation is large and outside temperature is high) based on output from the solar radiation amount sensor 64. In a case where the result of the determination is negative, the processing returns to step S6 and in a case where the result of the determination is positive, the processing proceeds to step S8.

In a case where the processing proceeds to step S8, the CPU 52 causes each introduction hole 32 to enter an open state by means of the opening and closing mechanism 84. Therefore, traveling wind (outside air) is introduced into the roof portion 18 and the outside air hits the radiator 40. Therefore, in a case where the outside temperature is high, the radiator 40 is warmed by traveling wind such that the battery pack 16 is warmed fast. When processing in step S8 is finished, the processing proceeds to step S11.

Meanwhile, in a case where the result of the determination in step S6 is negative and the processing proceeds to step S9, the CPU 52 detects whether or not the battery pack 16 needs to be cooled based on output from the battery pack ECU 17. In a case where the result of the determination is positive, the processing proceeds to step S8 and in a case where the result of the determination is negative, the processing proceeds to step S10.

In a case where the processing proceeds to step S10, the CPU 52 causes each introduction hole 32 to enter a closed state by means of the opening and closing mechanism 84. Accordingly, there is no introduction of traveling wind (outside air) into the roof portion 18. When processing in step S10 is finished, the processing proceeds to step S11.

In a case where the processing proceeds to step S11, the CPU 52 determines whether or not an ignition switch is off. In a case where the result of the determination is negative, the processing returns to step S6 such that the above-described processing is repeated and in a case where the result of the determination is positive, the control program for the opening and closing mechanism 84 is terminated. Note that, although not shown in FIG. 8, the CPU 52 causes each introduction hole 32 to enter a closed state by means of the opening and closing mechanism 84 in step S11. In the present embodiment, configurations other than those described above are the same as the first embodiment.

According to the present embodiment as well, the control program for the light control film 67 is also executed as with the first embodiment and thus the same effect as the first embodiment can be achieved. Furthermore, in the present embodiment, the controller 51 controls each opening and closing mechanism 84 based on the result of detection performed by the solar radiation amount sensor 64 and the battery pack ECU 17. Accordingly, each introduction hole 32 can be opened and closed and whether or not traveling wind is introduced into the roof portion 18 in which the radiator 40 is installed can be changed based on the result of the detection.

### Fourth Embodiment

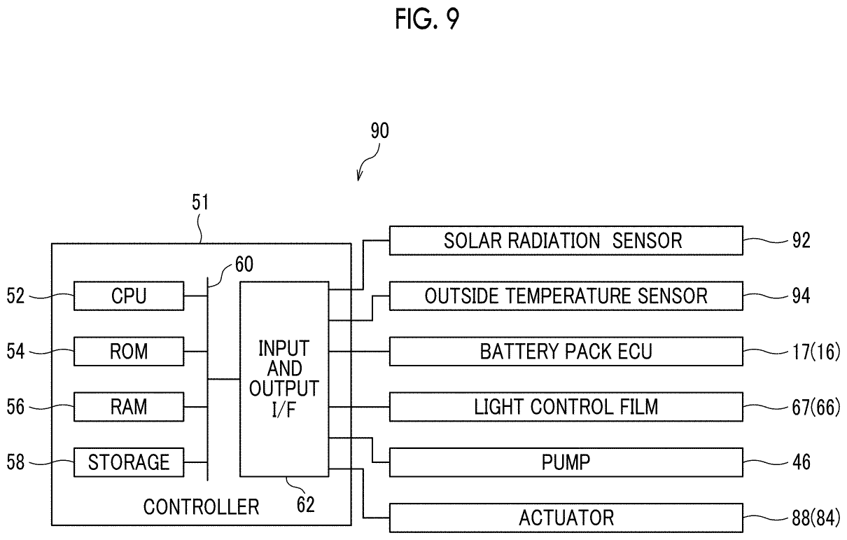

FIG. 9 is a block diagram showing the configuration of a vehicle temperature control system 90 installed in a vehicle according to a fourth embodiment of the disclosure. In the vehicle temperature control system 90, instead of the solar radiation amount sensor 64 described above, a solar radiation sensor 92 as a solar radiation detection unit is electrically connected to the input and output I/F 62 of the controller 51. In addition, an outside temperature sensor 94 as an outside temperature detection unit and the actuators 88 of the opening and closing mechanism 84 are electrically connected to the input and output I/F 62 of the controller 51.

The solar radiation sensor 92 is, for example, an optical sensor and is able to detect the presence or absence of solar radiation. The solar radiation sensor 92 is not limited to a sensor that directly detects solar radiation and may be a thermal photodetector that reacts to heat generated due to incidence of light, for example. In addition, the solar radiation sensor 92 may be a temperature sensor that detects the temperature of the outer panel 20 of the roof portion 18. The outside temperature sensor 94 is a temperature sensor attached to the vehicle body 11 on the outside of the vehicle cabin 12 and is able to detect the outside temperature.

In the vehicle temperature control system 70, as with the third embodiment, when the ignition switch (not shown) of the vehicle 10 is turned on and the battery pack 16 is activated, the CPU 52 of the controller 51 starts to execute a control program for the light control film 67 and to execute a control program for the opening and closing mechanism 84.

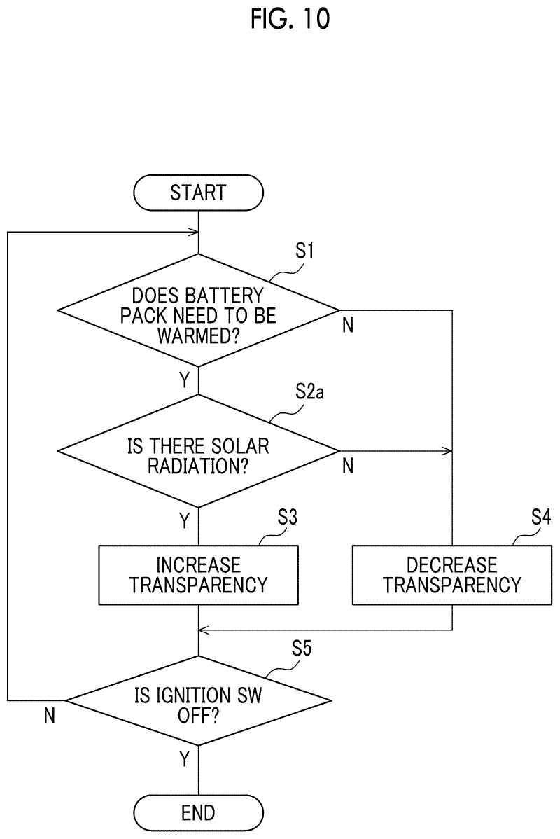

In the control program for the light control film 67, as shown in FIG. 10, the CPU 52 performs the same processing as in the first embodiment in step S1 and steps S3 to S5 except step S2a. In step S2a, the CPU 52 determines whether or not there is solar radiation based on output from the solar radiation sensor 92. In a case where the result of the determination is positive, the processing proceeds to step S3 and the transparency of the light control film 67 is increased. Meanwhile, in a case where the result of the determination is negative, the processing proceeds to step S4 and the transparency of the light control film 67 is kept decreased.

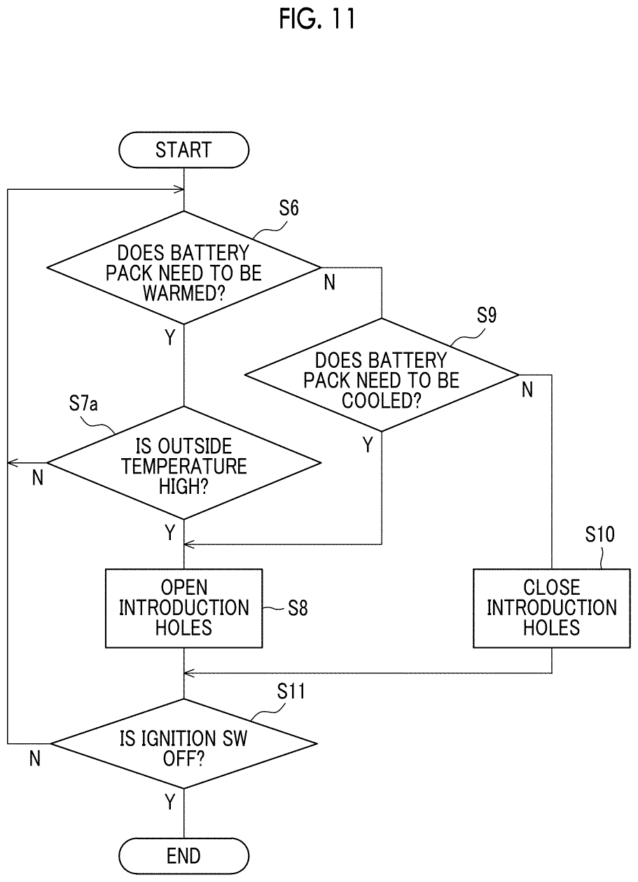

In the control program for the opening and closing mechanism 84, as shown in FIG. 11, the CPU 52 performs the same processing as in the third embodiment in step S6 and steps S8 to S11 except step S7a. In step S7a, the CPU 52 determines whether or not the outside temperature is equal to or greater than a pre-set threshold value (that is, whether or not outside temperature is high) based on output from the outside temperature sensor 94. In a case where the result of the determination is negative, the processing returns to step S6 and in a case where the result of the determination is positive, the processing proceeds to step S8 such that each introduction hole 32 is opened. In the present embodiment, configurations other than those described above are the same as the first embodiment.

In the present embodiment as well, the transparency of the cover member 66 (light control film 67) can be changed based on the result of detection performed by the solar radiation sensor 92. Accordingly, the radiator 40 can be irradiated with sunlight as needed. In addition, in the present embodiment, each introduction hole 32 is opened in a case where the CPU 52 determines that the battery pack 16 needs to be warmed in step S6 of FIG. 11 and determines that the outside temperature is high in step S7a. Therefore, the radiator 40 can be warmed by means of traveling wind such that the battery pack 16 is warmed fast.

Supplementary Description for Embodiments

Note that, in the fourth embodiment, the controller 51 may change the transparency of the cover member 66 based on the result of detection performed by the outside temperature sensor 94. Accordingly, the amount of sunlight with which the radiator 40 is irradiated can be changed in accordance with the outside temperature.

In addition, in each of the embodiments, the battery pack 16 is the temperature control target. However, the disclosure is not limited thereto. A temperature control target in an aspect of the disclosure may be a solar panel, an electronic control unit (ECU) for autonomous driving, or the like.

In addition, in each of the embodiments, the vehicles 10, 80 are electric vehicles. However, the disclosure is not limited thereto. A vehicle in an aspect of the disclosure may be a hybrid vehicle or a fuel cell vehicle.

In addition, in each of the embodiments, the radiator 40 as a heat exchanger is provided at the roof portion 18. However, the disclosure is not limited thereto. For example, a heat exchanger may be provided in an engine compartment of a vehicle front portion and a cover member may be provided on a hood.

In addition, in each of the embodiments, the radiator 40 is a heat exchanger. However, the disclosure is not limited thereto. A heat exchanger in an aspect of the disclosure is not for heat release, and may be any heat exchanger as long as the heating medium can be heated with the heat of sunlight.

In addition, the disclosure can be modified and implemented in various manners without departing from the scope of the disclosure. In addition, it is needless to say that the scope of rights of the disclosure is not limited to the above embodiments.

What is claimed is:

1. A vehicle comprising:
a temperature control target that needs to be subjected to temperature control;
a heat exchanger configured such that a heating medium circulates between the temperature control target and the heat exchanger;
a cover member that covers the heat exchanger and forms an upper surface of a vehicle body and of which a transparency is changeable;
a solar radiation detection unit configured to detect solar radiation; and
a controller that is able to change the transparency based on a result of detection performed by the solar radiation detection unit.

2. The vehicle according to claim 1, further comprising a state detection unit configured to detect a state of the temperature control target,
wherein the controller is able to change the transparency based on a result of detection performed by the state detection unit.

3. The vehicle according to claim 2, wherein:
the temperature control target is a battery pack; and
the state detection unit is able to detect a temperature of the battery pack.

4. The vehicle according to claim 2, wherein:
the temperature control target is a battery pack; and
the state detection unit is able to detect a state of use of the battery pack.

5. The vehicle according to claim 2, wherein:
the temperature control target is a battery pack installed below a floor of a vehicle cabin; and
the state detection unit is able to detect a temperature of the vehicle cabin.

6. The vehicle according to claim 1, wherein the solar radiation detection unit is able to detect an amount of solar radiation.

7. The vehicle according to claim 1, further comprising an outside temperature detection unit configured to detect a temperature of an outside of the vehicle,
wherein the controller is able to change the transparency based on a result of detection performed by the outside temperature detection unit.

8. The vehicle according to claim 1, wherein:
the heat exchanger is installed in a roof portion of the vehicle body; and
the cover member forms an upper surface of the roof portion.

9. The vehicle according to claim 8, wherein:
the heat exchanger is a radiator; and
an introduction hole for introduction of traveling wind into the roof portion is formed in the roof portion or a pillar of the vehicle body.

10. The vehicle according to claim 9, further comprising a state detection unit configured to detect a state of the temperature control target and an opening and closing mechanism configured to open and close the introduction hole,
wherein the controller is able to change the transparency based on a result of detection performed by the state detection unit; and
the controller controls the opening and closing mechanism based on a result of detection performed by the solar radiation detection unit and the state detection unit.
